(19) United States
(12) Patent Application Publication
(10) Pub. No.: US 2024/0020655 A1
(43) Pub. Date: Jan. 18, 2024

(54) METHOD AND SYSTEM FOR TRACKING ASSETS

(71) Applicant: OnPoint Group, LLC, Perrysburg, OH (US)

(72) Inventors: Kevin Snyder, Perrysburg, OH (US); Dennis Sanacore, Perrysburg, OH (US)

(21) Appl. No.: 18/353,457

(22) Filed: Jul. 17, 2023

Related U.S. Application Data
(60) Provisional application No. 63/368,554, filed on Jul. 15, 2022.

(51) Int. Cl. G06Q 10/20; G06Q 10/0635; G06Q 10/0639; G06T 7/00

(52) U.S. Cl. CPC G06Q 10/20; G06Q 10/0635; G06Q 10/06395; G06T 7/0004

(57) ABSTRACT

A method of conducting and reporting a survey includes generating a survey template comprising a plurality of asset assessment queries with each of the asset assessment queries corresponding to a request for data regarding an assessment of a status and/or condition of an associated one of the plurality of assets disposed at a survey site. A conducting of the survey by a surveyor includes the surveyor accessing the survey template during execution of a software application on a first user device and the surveyor submitting survey related data to a computing system regarding the status and/or condition of each of the associated assets as an entry to each of the corresponding asset assessment queries. The results of the survey are digitally reported to a customer organization following completion of the conducting of the survey.

### CROSS-REFERENCE TO RELATED APPLICATION

This patent application claims priority to U.S. Provisional patent application Ser. No. 63/368,554, filed on Jul. 15, 2022, the entire disclosure of which is hereby incorporated herein by reference.

### FIELD OF THE INVENTION

A system and method for tracking assets is disclosed, and more particularly, a system and method for surveying the condition of assets at a facility and digitally reporting the results of the corresponding survey to the owner or manager of the facility.

### BACKGROUND OF THE INVENTION

It is common for a logistics based facility or warehouse to include a variety of fixed assets that are in need of periodic assessment, repair, maintenance, or general management in order to maintain proper and safe operation thereof. Such assets may include loading docks, various doors and mechanisms thereof, fans, or the like. The status or condition of such assets may continuously change and may accordingly be subject to the need for periodic inspection and/or long-term tracking. Such assets may also be subject to various warranties such that evidence of the status of such assets may be beneficially recorded on a periodic basis.

There is, therefore, a need for an improved method of evaluating and tracking the assets found at a logistics based facility. The present invention addresses these challenges by providing a novel system and method that streamlines the process of conducting a survey with respect to the assets of a customer facility and then reporting the results of the survey to the customer facility.

### SUMMARY OF THE INVENTION

Concordant and congruous with the present invention, a system and method for surveying assets and digitally reporting the results of the corresponding survey has surprisingly been discovered.

According to an embodiment of the present invention, a method of conducting and reporting a survey regarding an assessment of a plurality of assets disposed at a survey site associated with a customer organization includes generating, by a computing system of a first business entity, a survey template comprising a plurality of asset assessment queries, each of the asset assessment queries corresponding to a request for data regarding an assessment of a status and/or condition of an associated one of the plurality of assets disposed at the survey site; conducting the survey by a surveyor, the conducting of the survey including the surveyor accessing the survey template during execution of a software application managed by the computing system on a first user device of the surveyor, the conducting of the survey further including the surveyor submitting survey related data to the computing system regarding the status and/or condition of each of the associated assets as an entry to each of the corresponding asset assessment queries during execution of the software application on the first user device of the surveyor; and digitally reporting results of the survey to the customer organization following completion of the conducting of the survey.

### BRIEF DESCRIPTION OF THE DRAWINGS

The above, as well as other advantages of the present invention will become readily apparent to those skilled in the art from the following detailed description of a preferred embodiment when considered in the light of the accompanying drawings.

FIG. 1 illustrates an enterprise system and environment thereof for engaging with a surveyor during navigation of an asset tracking and surveying platform, in accordance with one embodiment of the present invention.

FIG. 2 is a flow chart summarizing a method of carrying out a survey and reporting the results thereof according to the present invention.

FIG. 3 is an illustration of an administrator dashboard interface of the asset tracking and surveying platform as may be found on a display of a user device.

FIGS. 4 and 5 are each respective illustrations of a customer organization interface of the asset tracking and surveying platform as may be found on a display of a user device, wherein FIG. 4 includes the selection of a “sites” tab and FIG. 5 includes the selection of a “surveys” tab.

FIG. 6 is an illustration of a surveyor dashboard interface of the asset tracking and surveying platform as may be found on a display of a user device.

FIG. 7 is an illustration of a display of a user device when executing an annotation feature of the asset tracking and surveying platform with respect to an image of an asset.

FIG. 8 is an illustration of a graphic corresponding to the selection of a rating and the entry of a recommendation when editing an asset assessment query of a corresponding survey.

FIG. 9 is an illustration of a graphic corresponding to the scanning or manual entry of an optical code when editing an asset assessment query of a corresponding survey.

FIGS. 10 and 11 are illustrations of exemplary configurations of survey related data when reported to a customer following the completion of a corresponding survey at a customer associated survey site.

### DETAILED DESCRIPTION OF EXEMPLARY EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

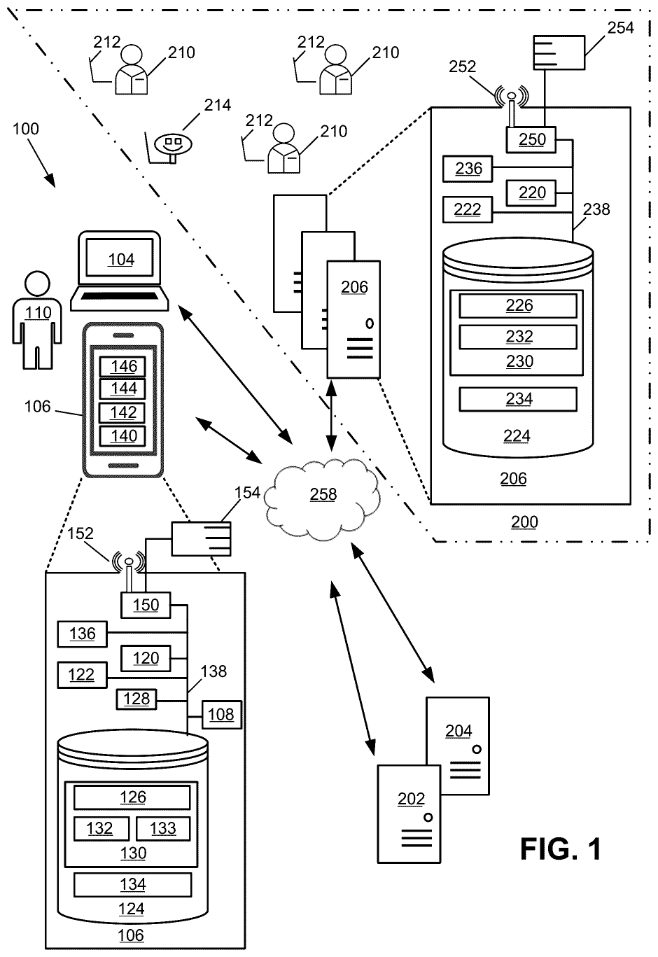

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the illustrated applications 132, 133 are represented as particular examples. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110 in accordance with the system and method of the present invention. In some examples, the enterprise system 200 offers products, and in other examples, the enterprise system 200 offers services. Use of “service(s)” or “product(s)” thus relates to either or both in these descriptions. In non-limiting examples, services and products include information services and products, custom services and products, predefined or pre-offered services and products, consulting services and products, or advising services and products.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, online customer service assistants available to users 110, advisors, project managers, sales team members, technicians, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1. As used hereinafter, it is assumed that references to the enterprise system 200 performing an action related to the collection, transfer, or analysis of data is referring to an action being taken by the appropriate components of the computing system 206 of the enterprise system 200 as described herein. Similarly, references to such actions being performed by the computing devices 104, 106 or the external systems 202, 204 should be assumed to be performed by corresponding components thereof.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent third party sources of data associated with a specific accounts, such as repositories of such data or entities responsible for the collection of such data.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The present invention relates to a system and method of tracking surveyed assets associated with a specified customer operated facility, which may alternatively be referred to hereinafter as the survey site. The system and method includes the use of a software application 132 managed by the enterprise system 200, and more specifically, managed by the computing system 206 of the enterprise system 200. The software application 132 may be executable on any of the described user devices 104, 106 or agent devices 212 and provides a graphical interface for each user 110, 210 of the software application 132 to interact with data associated with at least one survey of assets conducted by a surveyor associated with the enterprise system 200.

The present invention is described hereinafter with reference to navigation of the software application 132, but it should be understood that the present invention is not limited to the use of a dedicated software application 132 executable on one of the described user devices 104, 106 or agent devices 212 in viewing or organizing the survey related data described herein. Instead, the features described herein may similarly be accessed via a corresponding website accessible via a web browsing application executable on any of the described user devices 104, 106 or agent devices 212, wherein such a website may include the same or similar interfaces for accomplishing the same tasks as described with respect to the application 132. It is generally assumed hereinafter that the same features of the present invention may be accessible via use of the website accessible via the browser application or the direct use of the software application 132. It should also be generally understood that the website and the software application 132 may generally include the display of the same data regarding the surveys and the interactions therewith, but may in some circumstances include a different arrangement of such data to best accommodate the configuration of the corresponding user device 104, 106, such as accommodating a specific screen configuration or a specific user input method.

The methods disclosed herein also include references to the computing system 206 responsible for communicating data necessary for the operation of the software application 132 storing data or files relating to a facility, customer, organization, surveyor, and/or survey to the storage device 224 thereof. As utilized herein, the storage device 224 of the computing system 206 is not limited to a storage device exclusively managed by the enterprise system 200, and may instead refer to a third-party data storage device in communication with the computing system 206, or any other form of storage device 224 associated with and accessible by the computing system 206. That is, as opposed to storing all associated data to a storage medium maintained directly by the enterprise system 200, the enterprise system 200 may utilize an external storage medium managed by a third-party entity for storing such data. The application 132 according to the present invention may accordingly utilize cloud-based functions to transfer data between the computing system 206 and any corresponding third-party entity, such as one of the described external systems 202, 204, during navigation of the software application 132 for sending and/or retrieving the desired data at the desired instance. It is accordingly not critical to the present invention that the acquired data be stored to a specific storage device or location, so long as the application 132 routes the desired data to the corresponding user for display thereto in accordance with the novel features of the present invention.

As used herein, each corresponding survey site may refer to a bounded area (parcel) of real property, a contiguous set of parcels of real property, an identifiable building or structure found on one or more parcels of real property, a unit or sub-unit of a building or structure, or a campus/facility comprising a plurality of contiguous buildings, structures, or the like, as non-limiting examples. Each survey site may include geo-positional data associated therewith, such as utilizing the longitude and latitude coordinates of the geographic coordinate system (CGS) in identifying the geographic position of the survey site. Each survey site may include a street address that is associated with the geo-positional data to allow the survey site to be discoverable via the GPS-based navigation methods typical of smart devices such as any of the disclosed user devices 104, 106 or agent devices 212. Each survey site may be described by a set of nominal coordinates corresponding to a point position within the respective survey site as established by the street address of the work site. For example, a survey site corresponding to a parcel of property covering a two-dimensional area may include a nominal point position at a two-dimensional (longitude and latitude) center of the area bound by the perimeter of the survey site, and the coordinates of this nominal point position of the survey site may be utilized in identifying the geographic position of the survey site. The nominal point position may correspond to any position within the survey site, as desired, in addition to the example of the center point.

Each survey site is associated with a customer of the enterprise system 200 that has requested the services of the enterprise system 200 in carrying out a survey for the tracking of assets at the corresponding survey site in accordance with the present disclosure. The customer may refer to the person or entity owning, managing, or otherwise having authority over the corresponding survey site, or to an authorized agent of such a person or entity having the authority to act in such a capacity.

The enterprise system 200 may be responsible for the management of one or more assets at each of the different survey sites at which a survey may be carried out. Such assets may refer to any parts, equipment, structures, installations, or the like that are in any way maintained or monitored by the enterprise system 200. The enterprise system 200 may also be associated with one or more third-party affiliate organizations that aid in carrying out the surveys associated with the software application 132. That is, the enterprise system 200 may be representative of an entity that contracts with or otherwise employs one or more third-party entities to carry out the surveys that originate from the enterprise system 200, via the request of a customer of the enterprise system 200. Each affiliate organization may in turn employ or contract work to at least one surveyor capable of performing the survey in accordance with the requirements and standards of the enterprise system 200. Such surveyors may be assumed to have sufficient training and/or certification in performing tasks with respect to the assets managed by the enterprise system 200. Each affiliate organization may further employ or contract work to at least one administrator or manager responsible for carrying out tasks associated with use of the application 132, wherein such an administrator or manager does not directly technically engage with the survey site when performing the task specified by the survey request, but instead delegates such a task to a specified surveyor and/or performs administrative or management related tasks related to carrying out the survey. However, it should also be understood that each affiliate organization may include a single person or any grouping of multiple persons carrying out any combination of the described technical and administrative tasks, depending on the circumstances of each individual affiliate organization, hence the present invention is not limited to requiring the use of distinct administrators and technicians when completing the process of assigning and completing a survey. For example, it is conceivable that an administrator or manager also having appropriate technical training and certification, or a technician having administrative or management authority with regards to the affiliate organization, may be capable of carrying out any and all of the steps stated as being associated with one of the affiliate organizations when utilizing the application 132.

The present system and method is described hereinafter wherein the surveyor conducting the associated survey is an employee or contractor who reports directly to the enterprise system 200, rather than being associated with a third-party affiliate organization having similar capabilities. Such a surveyor performing the survey may accordingly correspond to the described user 110 of one of the user devices 104, 106 that is in communication with the computing system 206 of the enterprise system 200 via the associated software application 132, and may thus be referred to as the surveyor 110 hereinafter. The present system and method is further described hereinafter wherein any administrative functions that may be achieved via use of the computing system 206 and/or the software application 132 are conducted by an administrator acting as an employee or contractor who reports directly to the enterprise system 200, rather than being an administrator of a third-party affiliate organization having similar responsibilities. Such an administrator may accordingly corresponding to one of the agents 210 of the enterprise system 200 having access to a corresponding agent device 212 for interacting with the computing system 206 and/or the software application 132, and may thus be referred to as the administrator 210 hereinafter. It should be readily apparent to one skilled in the art that the same processes and functions may be applied to a circumstance wherein an administrator and/or surveyor associated with a third-party affiliate organization is responsible for performing the administrative and survey-related tasks for properly assigning, completing, and reporting a survey according to the present invention, so long as all corresponding parties have access to the same permissions and capabilities when utilizing the computing system 206 and/or software application 132 in creating or editing content related to a corresponding survey, or in sorting or searching a listing of all relevant surveys. The use of a third-party affiliate organization in carrying out the present system and method is accordingly within the scope of the present invention.

Each survey conducted via use of the application 132 may be associated with a corresponding customer organization account. Each customer organization account may in turn be associated with one or more survey sites, wherein each survey site may correspond to a distinct location or a sub-unit of a larger location. Each survey site may in turn be associated with one or more surveys conducted with respect to the corresponding survey site. Each individual survey site may be associated with geopositional data for determining a geographic position of the corresponding survey site, such as by use of GPS services of a corresponding user device 104, 106. The geopositional data may be associated with an address of the survey site in question, or may be established by an administrator 210 or a surveyor 110 of the enterprise system 200. The computing system 206 may accordingly organize the data stored with respect to each of the surveys conducted according to the corresponding customer organization account and/or the survey site associated with each respective survey.

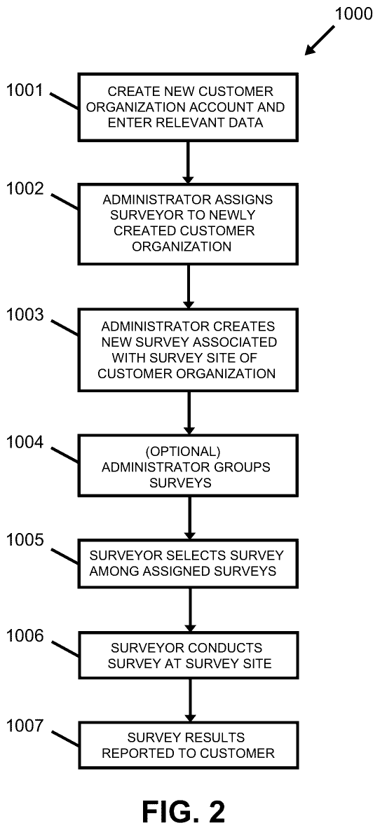

Referring now to FIG. 2, a flow chart 1000 showing a representative method of operation of the present computing system 206 and associated software application 132 according to an embodiment of the present invention is disclosed. The flow chart 1000 illustrates the method as progressing from the creation of a customer organization account within the software application 132, the conducting of the corresponding survey, and then the reporting of the survey results to the associated customer organization.

In a step 1001, the administrator 210 utilizes an interface of the application 132 or direct access to the computing system 206 to create a new customer organization account corresponding to at least one new survey site having assets in need of a survey. The creation of the customer organization account may include the entry and storage (to the storage device 224 of the computing system 206) of all relevant data relating to the customer organization, including the name of the organization, the address of the organization, and any other contact information regarding the organization. The creation of the customer organization account may further include the creation of a plurality of different survey sites associated with the customer organization, wherein each created survey site may be created via the entry and storage of an identifier (custom name) of the survey site, the address of the survey site, and any contact information relating to the survey site. The step 1001 may further include the ability to edit any of the data entered in establishing the creation of the customer organization account, and/or the deletion of any created customer organization accounts, as desired.

The creation of the customer organization account may further include the ability to upload a graphic image corresponding to a logo or the like representative of the customer organization during use of the application 132 or access to the computing system 206. The software application 132 may be further configured to determine which color or colors are most prominent in the uploaded image to determine one or more theme colors to suggest to the administrator 210 to be assigned to the customer organization account. The software application 132 may also offer an option to the administrator 210 to choose one or more of the custom colors via a color selection option. The logo and/or the theme color(s) may be presented graphically during navigation of the software application 132 adjacent to or in conjunction with any data corresponding to the associated customer organization and/or surveys conducted with respect thereto, or may be presented in any reports or other documentation generated by the software application 132 during the process of conducting and reporting a survey. Such a feature advantageously allows for identification of the corresponding customer organization more easily via the use of the customized logo and/or theme color(s), and/or provides a more customized and professional appearance when generating reports or documentation with respect to a specific customer organization.

In a step 1002, the administrator 210 selects a surveyor 110 to assign to the now created customer organization account via use of the application 132 or access to the computing system 206. In some embodiments, the assignment of a surveyor 110 to a customer organization may result in the capability of the corresponding surveyor 110 being able to access and/or interact with all of the data associated with the corresponding customer organization, including the ability to access data associated with any and all survey sites and surveys thereof, regardless of the participation of the corresponding surveyor 110 in conducting the survey with respect to each of the survey sites. In other embodiments, each surveyor 110 may only be assigned to certain respective survey sites among a plurality of such survey sites, and the corresponding surveyor 110 may only have permission to access and/or interact with data associated with those survey sites that have been assigned to the corresponding surveyor 110. In yet other embodiments, each surveyor 110 may only be assigned certain surveys to be conducted with respect to the customer organization and the survey sites thereof, and the corresponding surveyor 110 may only have permission to access and/or interact with data associated with those surveys that have been assigned to the corresponding surveyor 110.

The step 1002 may in some circumstances include a change to which of the surveyors 110 associated with the enterprise system 200 is assigned to and having permission to access and/or interact with a selected one of the customer organizations, survey sites, or surveys. That is, the administrator 210 may remove or add surveyors 110 that are eligible to access and/or interact with the customer organization, survey sites, or survey, or may edit details corresponding to each selected surveyor 110, as desired, via use of the application 132 or access to the computing system 206. The selection of each surveyor 110 that is assigned to the corresponding customer organization/survey site/survey may include selecting each surveyor 110 from an existing list of eligible surveyors 110 or may include creating a new account regarding a new surveyor 110, as necessary.

Once the customer organization account is established and at least one surveyor 110 has been assigned to perform a survey with respect to the established customer organization account, a step 1003 includes the administrator 210 creating a new survey to be associated with a selected one of the customer organization accounts, and more specifically with one of the survey sites thereof, via use of the application 132 or access to the computing system 206. The step 1003 may include the entry of a unique name or identifier of the survey, the selection of the survey site with which the survey is associated among the one or more survey sites associated with the customer organization, and the assignment of at least one the surveyors 110 having been assigned appropriate permissions with respect to the customer organization in step 1002 to conduct the survey being created. The step 1003 may also include the uploading of any images that the administrator 210 may choose to associate with the customer organization account for display with respect to the survey or any reports generated as a result thereof, such as one of the logos or the like disclosed as being utilized in the step 1001. The step 1003 may also include the editing of any of the details described as being entered in creating the survey, including reassignment of different surveyors 110 or the correction of the designated survey site.

The creation of the survey in step 1003 may include the administrator 210 adding one or more asset assessment queries to the created survey, wherein each asset assessment query added to the survey corresponds to an assessment request with respect to an asset found at the corresponding survey site. Each asset assessment query may accordingly relate to an asset being monitored by the enterprise system 200 on behalf of the customer organization at the selected survey site. Each asset assessment query may be associated with a type of asset (fan, door, ramp, etc.) and a position of the asset within the survey site. The different asset assessment queries may accordingly be sorted or grouped by the type of asset or by the position of the asset within the survey site. For example, a first position at the survey site may include a first fan, a second position may include a second fan and a third fan, and a third position may include a first loading dock and a first loading door. An individual asset assessment query may be added to the survey for each of the first fan, the second fan, the third fan, the first loading dock, and the first loading door, with the type and position of each corresponding asset established at the time of creation of the corresponding asset assessment query. The asset assessment queries may thus be grouped according to one of the three exemplary positions, or one of the three exemplary different types of assets (fan, loading dock, or loading door), according to the present example. The adding of the asset assessment queries to the survey accordingly creates a form of checklist for the assigned surveyor 110 to utilize in ensuring that each and every asset in need of assessment at the corresponding survey site in accordance with the requested survey is accounted for and properly assessed at the time of the conducting of the survey. The survey, as created by the computing system 206, may hereinafter be referred to as the survey template due to the manner in which the survey includes an organized collection of the requests for the assessment of the assets associated with the survey site in the manner described.

The creation of each of the asset assessment queries may further include the corresponding administrator 210 adding any other known information about each of the assets to be stored as data associated with the corresponding asset assessment query. For example, where known, the administrator 210 may enter and store data relating to each asset such as the manufacturer thereof, the model or serial number thereof, any digital files associated with instructions or other manuals associated with repair, assembly, or maintenance of the corresponding asset, any visual identification data relating to the corresponding asset (such as a QR-code, barcode, or the like), or any documented data regarding a condition of the asset, prior repair to the asset, prior replacement of the asset, or the like.

In order to save time and effort, the application 132 may provide a feature wherein each existing asset assessment query may be copied an appropriate number of times to result in the generation of a plurality of the asset assessment queries that are identical to each other with the exception of an identifying characteristic thereof, such as labeling each copy with a different letter or number for signifying one of a plurality of the copies. For example, a fan asset entry may be copied twice to result in three asset assessments named “fan,” “fan—copy 1,” and “fan—copy 2.” The copying of the asset assessment query may include any data entered with respect to the original asset, such as the type, model, or position thereof, being copied to the copied asset assessment query to prevent the need to repeatedly enter the same or similar data with respect to each of a plurality of otherwise similar or identical assets. Any minor differences among the copied asset assessment queries, such as differences in position or serial number, may then be manually edited to differentiate the otherwise identical assets, where needed.

The creation of the asset assessment queries has thus far been described as occurring as a result of the actions of the administrator 210, but it should be apparent that it is within the scope of the present invention for an on-site surveyor 110 to add new asset assessment queries or to edit existing asset assessment queries where errors or omissions are discovered during in-person review of the survey site. The step 1003 may also include the administrator 210 editing or adding any asset assessment queries following the initial creation of the survey.

The flow chart 1000 illustrates an optional step 1004 wherein the administrator 210, via use of the application 132 or access to the computing system 206, creates one or more survey groups to be associated with a corresponding one of the customer organization accounts. Each survey group corresponds to a desired grouping of the surveys performed with respect to a corresponding customer organization account according to any criteria. As one representative example, each survey group may be representative of a common geographic location where multiple survey sites are located, hence each survey group may correspond to all survey sites found at one of the geographic locations where multiple survey sites are present. Such a circumstance may be utilized where an organization includes multiple different site locations each having multiple different survey sites associated therewith, such as having multiple campuses with each campus having multiple distinct buildings that serve as individual survey sites. The use of the survey group feature may allow for all reports or relevant data associated with all surveys performed with respect to one of the created groups being reported or displayed simultaneously or in a common report to more easily group all data corresponding to the selected grouping criteria. For example, where each building of a campus is a separate survey site and the customer organization is associated with multiple campuses, the grouping feature may allow for the generation of a report or the display of data relating to the results of all surveys conducted with respect to all of the survey sites found on the corresponding campus, thereby allowing for all data regarding the overarching geographic location corresponding to the campus to be viewable contemporaneously, rather than relying upon distinct and independently reported data with respect to each building corresponding to a survey site within the grouping. The step 1004 may include an editing of any of the data entered in establishing one of the groups or may include deleting a created group, as desired.

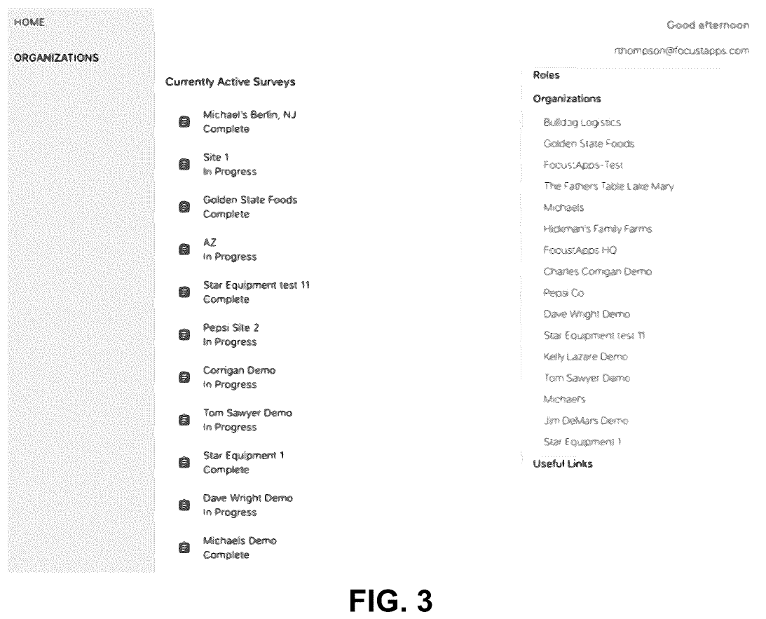

Referring now to FIG. 3, a representative dashboard interface as may be displayed during execution of the software application 132 on a user device 104, 106 or an agent device 212 is shown. The dashboard interface provides an interface for sorting through the survey related data discussed above in steps 1001-1004 to allow an administrator 210 and/or an assigned surveyor 110 to easily determine a priority of tasks to be completed regarding the assigned surveys. As shown on the right of the display, the dashboard interface may include the ability to select one of a plurality of the customer organization accounts to gain access thereto for viewing and/or editing any data relating to the customer organization account, including the data established during any of the steps 1001-1004. The left of the display includes a listing of all active surveys associated with all of the customer organizations to which the corresponding administrator 210 has access and appropriate permissions to add or edit any associated data. The active surveys in the listing relate to any surveys that are in progress or recently completed within a specified time frame. Interaction with an interactive area of the display corresponding to one of the listed active surveys may lead to the downloading of or redirection to a survey report having an arrangement of all collected data associated with the selected survey.

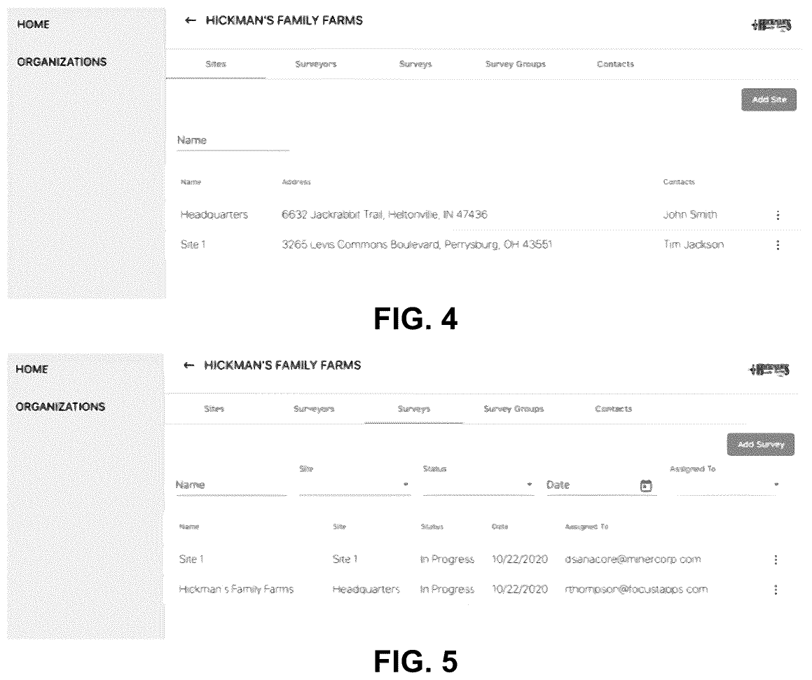

Referring now to FIGS. 4 and 5, two representative examples of a customer organization interface are shown, wherein such a customer organization interface may be displayed on the user device 104, 106, 212 following the interactive selection of one of the interactive areas of the display corresponding to one of the listed customer organizations on the right side of FIG. 3. The customer organization interface allows for the review of all collected or entered data with respect to the selected customer organization while also allowing for the creating/editing of such data in accordance with any of the described steps 1001-1004. The illustrated customer organization interface is shown as including tabs corresponding to the selection of “sites,” “surveyors,” “surveys,” survey groups,” and “contacts” that are associated with the selected customer organization. Each tab lists the relevant data with regards to the selected tab for sorting and organizing such data in a comprehensive and easily searchable manner. As can be seen in FIG. 4, the selection of the “sites” tab results in a listing of all created survey sites associated with the selected customer organization, wherein each listed survey site may be selected for editing where a change in data is required. The selection of the “sites” tab also results in the presence of an interactive area corresponding to the addition of a newly created site in accordance with step 1001. FIG. includes the selection of the “surveys” tab, which in turn results in the ability to add a new survey, view any already conducted surveys, or edit any data corresponding to one of the already conducted surveys. It should be readily apparent that the remaining tabs may similarly be utilized in adding or editing the eligible surveyors 110 assigned to the selected customer organization when selecting the “surveyors” tab, adding or editing any survey groups associated with the customer organization when selecting the “survey groups” tab, or adding or editing any contacts or contact information associated with the customer organization when selecting the “contacts” tab.

The displays of FIGS. 3-5 may be representative of a web-site interface accessible via an associated web browser, which is described herein as being equivalent to the described software application 132, and may be particularly well suited for navigation of the survey related data by one of the administrators 210 of the enterprise system 200, which may be primarily tasked with the management of the customer organization accounts, the creation of each new survey, the selection of the asset assessment queries to be included in the created survey, and the selection of the surveyor(s) assigned to the survey. However, the same data may be accessible utilizing the same sorting and filtering features in a dedicated version of the software application 132 having a configuration between suited for a mobile device such as the described user device 106.

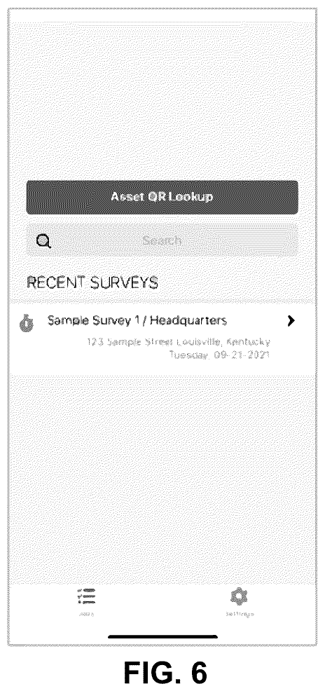

Referring now to FIG. 6, an exemplary surveyor dashboard interface is shown as may be displayed when one of the surveyors 110 is accessing the application 132 via a corresponding user device 104, 106, as may be utilized during the process of conducting the survey at the physical location of the corresponding survey site. The surveyor dashboard interface may be accessible to a corresponding surveyor 110 following execution of the application 132 on the user device 104, 106 and the entry of login credentials for establishing and confirming the identity of the surveyor 110 utilizing the application 132. The confirmation of the identity of the surveyor 110 results in the surveyor dashboard interface displaying a list of all pending, in progress, or recently completed surveys. In FIG. 6, the corresponding surveyor 110 has only one currently assigned survey entitled “Sample Survey 1/Headquarters,” which is presented along with an address of the survey site corresponding to the survey and the date of assignment of the survey. The surveyor dashboard interface may be utilized by the surveyor 110, during use of the application 132, to select one of the non-completed surveys to which the surveyor 110 is assigned when the surveyor 110 is ready to complete the selected survey.

Although not shown in FIG. 6, the listing of such assigned surveys may also include the ability to sort or filter the assigned surveys according to any appropriate filtering criteria, as desired, such as the status, name, location, date of assignment, or the like. The surveyor dashboard interface may have the same functionality as is disclosed with regards to the dashboard interface of FIG. 3.

Referring back to FIG. 2, the flowchart 1000 includes a step 1005 wherein the surveyor 110 selects an assigned one of the surveys among all pending surveys to begin the process of conducting the survey. As mentioned above, it is assumed that the surveyor 110 has already logged-in successfully and confirmed his or her identity before having access to a survey to be completed. In some embodiments, the selection to begin conducting the survey may include a map or navigation application or feature of the user device 104, 106 communicating with the application 132 during utilization of the GPS capabilities of the user device 104, 106 to aid in directing the surveyor 110 to the correct survey site geographic location. As noted previously, each survey site may be associated with geopositional data and/or an address that aids in establishing directions to such a survey site.

A step 1006 includes the surveyor 110 conducting the selected survey at the survey site upon arrival thereat. The step 1006 generally includes the surveyor 110 editing each of the existing asset assessment queries to include the most up-to-date assessment data and/or to add/correct any missing/incorrect assessment data to reflect the instantaneous and professionally ascertained condition of each corresponding asset. The step 1006 may also, in some circumstances, include the surveyor 110 creating new asset assessment queries corresponding to new and previously undocumented assets that are included in the survey, where determined to be applicable for such addition. The application 132 may sort or filter the asset assessment queries according to any desired criteria during the conducting of the survey for displaying a list of the asset assessment queries to the surveyor 110 in any desired configuration. According to one example, the asset assessment queries are grouped according to the different positions of the survey site. According to another example, the asset assessment queries are grouped according to the different asset types associated therewith. In any event, the surveyor 110 progresses through the survey site and enters new or modified data with respect to each available field of each previously created or contemporaneously created asset assessment query to enter all available data regarding all applicable assets at the survey site in question.

The step 1006 may include the performance of various different functions and features of the application 132 when executed on the user device 104, 106 in providing the most comprehensive and evidence-based assessment of each asset as described hereinafter in the following examples. According to one feature, the application 132 may include the ability to access a camera feature of the associated user device 104, 106 and/or a file location of any images or videos taken via the camera feature in order to allow for the camera feature and stored images/videos of the user device 104, 106 to be utilized in recording evidence regarding the assessment of each asset in the editing of the corresponding asset assessment query. The process may include the surveyor 110 selecting an interactive area on the display of the user device 104, 106 indicating access to the camera where a new picture is required or access to a image/video storage location of the user device 104, 106 where a previously taken image or video is desired for uploading. Once a suitable photograph of video is taken of the asset in question to display some aspect of the condition thereof, the image and/or video file associated therewith may be uploaded, via use of the application 132, from the user device 104, 106 to the computing system 206 for storage to the storage device 224 thereof. Any such uploaded image or video files may be uploaded according to a field of the corresponding assess assessment query, such as a field requesting photographic or video evidence of the asset corresponding to the assessment query.

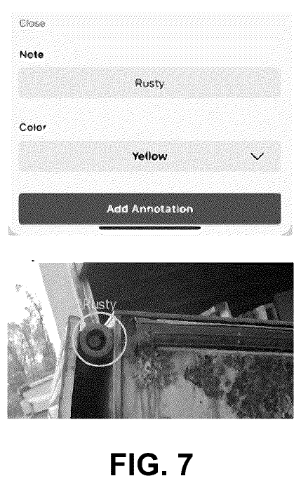

According to one particularly useful feature, the uploading of the photographic or video evidence may further include the application 132 having an editing feature wherein certain annotations or other visual alterations may be made to the corresponding image or video for better illustrating the identified condition of the asset, such as where a safety hazard or area in need of repair is identified. Referring now to FIG. 7, one example of an annotation feature that may be provided is disclosed according to an exemplary display of the application 132 following the selection to annotate over an uploaded image. The annotation feature may allow for the addition of a graphic, such as a circle, arrow, line, box, etc., to be drawn or otherwise overlaid relative to the uploaded image or video at a position corresponding to a feature thereof in need of identification and notation. In the example of FIG. 7, such an annotation includes the entry of a note regarding text to be included in the annotation and the selection of a color of the annotation identifier (a circle in the present example) utilized along with the text-based note. Alternative image and/or video editing features may be utilized in addition to those shown and described where such features draw attention to a visually identifiable feature of the assets being photographed or recorded.

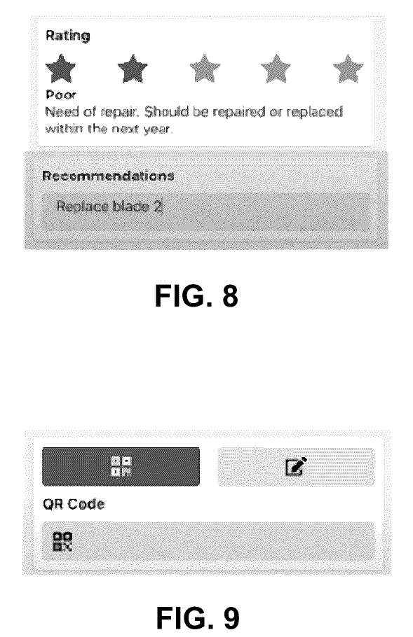

Referring now to FIG. 8, another feature of the application 132 may include each asset assessment query providing the selection of a rating of the corresponding asset by the surveyor 110 in accordance with the expertise and training of the surveyor 110 along with any text-based notes and/or recommendations corresponding to the selected rating and/or condition of the asset. In the example of FIG. 8, a star rating system is utilized wherein a rating of 1-5 is assigned to assess the condition of each asset, and notes are provided alongside the rating to indicate a suggested course of action in addition to the condition of the asset.

According to yet another feature of the current invention, each asset having an asset assessment query associated therewith may also be associated with an optical code displayed thereon. The optical code may be physically disposed on the corresponding asset, such as by a printed marker or the like, by the surveyor 110 during the conducting of a survey where any assets are discovered to be devoid of a corresponding optical code. The optical code may be, for example, a QR code or a barcode, as non-limiting examples. The conducting of the survey may include the surveyor 110 utilizing the camera feature of the corresponding user device 104, 106 visually scan the optical code associated with each asset when editing the corresponding asset assessment query. That is, for each asset assessed by the surveyor 110, the surveyor 110 may select an interactive area of the display of the user device 104, 106 indicating the desire to scan the optical code of the asset instantaneously being assessed to associate the scanned optical code with the asset being assessed. In other embodiments, the surveyor 110 may manually enter any code information displayed on the optical code where the scanning of the optical code is not available. FIG. 9 illustrates one exemplary interface for choosing whether to scan the corresponding optical code or to manually enter the text-based data associated with the corresponding optical code. Each assessed asset may thus be associated with an optical code that can be scanned to access any necessary data regarding the corresponding asset as recorded during the conducting of the survey.

Another feature of the present invention may include the ability of the surveyor 110 to utilize the GPS services of the user device 104, 106 to identify a specific geographic position of each asset evaluated in accordance with one of the asset assessment queries. That is, when assessing an asset, the surveyor 110 may record the geopositional data of the user device 104, 106 when at or adjacent the position of the corresponding asset to record the location of the corresponding asset to the asset assessment query as one data entry thereof. The recording and submitting of such data may include a GPS tracking feature of the user device 104, 106 being activated at the time of recordation/submission. Each and every asset identified by such a method may accordingly be easily found via use of the GPS services of the user device 104, 106 when seeking to rediscover the position of an asset upon a return to the survey site.

In some embodiments, the step 1006 may include a need to complete a safety assessment of the survey site in accordance with any applicable regulations or guidelines associated with the types of assets being assessed before the survey can be considered complete and available for submission. Such a safety assessment may include queries relating to activities and conditions identifiable to the surveyor 110 during the conducting of the survey at the survey site, such as whether certain applicable safety guidelines are being adhered to by staff or whether the assets are configured in a safe and compliant manner.

The step 1006 includes the surveyor 110 submitting the conducted survey once all necessary fields of all available asset assessment queries have been sufficiently addressed by the surveyor 110 in accordance with the requirements of the enterprise system 200. The submission of the survey may include the results of the survey being reviewed by an administrator 210 of the enterprise system 200 prior to forwarding the results onward to the customer organization, as desired.

The method according to the present invention includes a step 1007 of digitally reporting the results of the survey to the customer organization following the completion of the survey and the optional approval of the administrator 210 of the enterprise system 200. In some embodiments, the reporting of the survey results includes the application 132 generating a web-page associated with the survey that includes a report of all relevant data associated with the survey site and the assets thereof as entered by the administrator 210 during the creation of the survey or entered by the surveyor 110 during the conducting of the survey process at the survey site. In other embodiments, the results of the survey are organized in a database compliant format where the relevant data may be uploaded to a corresponding data management or spreadsheet application for further data analysis. In other embodiments, an image or other file reporting the results of the survey in similar fashion to the web-site may be generated and the corresponding file may be sent to the customer organization via an appropriate messaging technique.

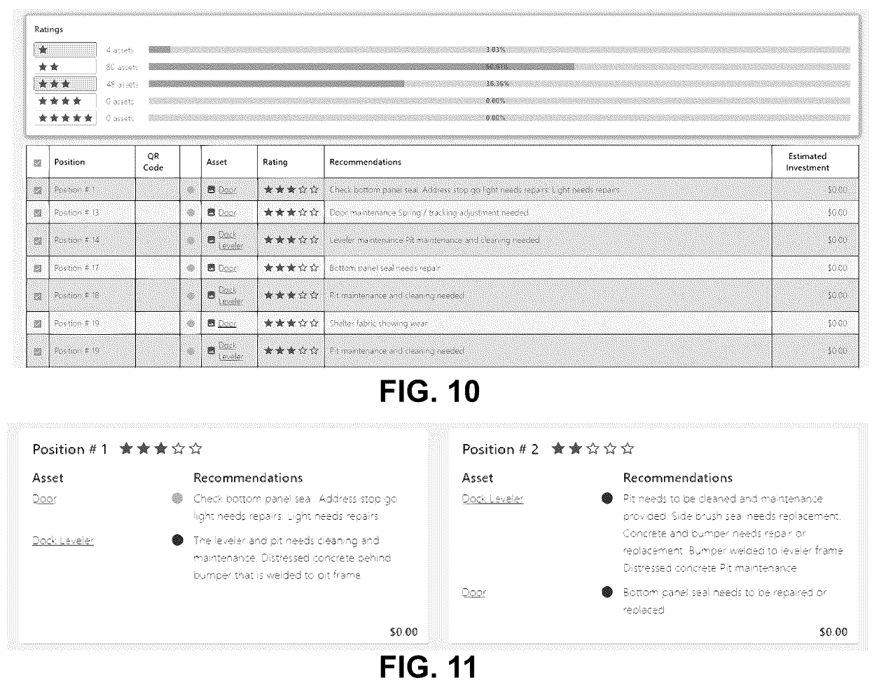

The report generated as a result of step 1007 may include any sorting, filtering, or grouping of the asset related data for illustrating the condition of the assets individually or collectively, whether by survey site, by position within the survey site, or by asset type. The report, where digitally interactive such as where a website is generated, may also include access to all images and/or videos uploaded with respect to each asset assessment query to allow for the visualization of all noted features and recommendations. FIGS. 10 and 11 illustrate exemplary aspects of a report as may be generated in the step 1007 for reporting to the customer organization. FIG. 10 includes a chart listing the various positions, assets, ratings, recommendation notes, etc., along with a summary of the results of the assessment of all associated assets, including a count of the different assigned 1-5 star ratings. FIG. 11 illustrates an alternative configuration of data wherein each of the positions at which the assets may be associated at the survey site may be displayed alongside each of the assets and recommendations associated with the corresponding survey site position.

In some circumstances the report, whether generated as a file communicated to the customer organization or a website accessible by the customer organization, may be associated with multiple different surveys and/or multiple different survey sites where the report is generated with respect to one of the survey groups created as a part of the optional step 1004. That is, a report may include the results of multiple different surveys conducted at one or more survey sites where it is desirable to present all such data contemporaneously. For example, some customer organizations may include two or more different survey sites corresponding to two adjacent buildings at a common campus of the customer organization, hence it may be useful to provide a report including all relevant data regarding both buildings at the same general geographic location. In other circumstances, the grouping of surveys for creating a report may be utilized to assess the status of assets across a plurality of different survey sites for assessing an overall view of the condition of the assets associated with the corresponding customer organization.

The use of the system and method as disclosed herein provides numerous advantages to all associated parties. By utilizing the interactive assessment system offered by the application 132, customers can bolster safety measures for their company and employees. The ability to access real-time conditions of the survey site through data and electronic evidence ensures prompt identification of potential risks or hazards. The system leverages data and electronic evidence to provide customers with immediate insights into the condition of their facility. This facilitates proactive maintenance, allowing customers to address issues promptly and to mitigate downtime. The invention aids customers in their budgeting efforts by providing accurate information about the assets within their facility/warehouse. By having a comprehensive overview of equipment performance and condition, customers can optimize their budget allocation while minimizing the total cost of ownership. The interactive assessment system offered by the application 132 enables customers to establish warranty support by comparing equipment performance year over year. By leveraging the collected data, customers can ensure compliance with warranty requirements and identify areas where performance improvements can be made. The invention also assists customers in preparing for upcoming inspections of their facilities. By having all asset-related information readily accessible and organized within the software application 132 and/or the generated report of the survey of the corresponding survey site, customers can ensure compliance with inspection requirements and streamline the inspection process. In summary, the system and method described herein offer customers a comprehensive and interactive solution for assessing their equipment within their facility/warehouse. By providing real-time data, supporting budgeting efforts, and enhancing safety and security measures, the present invention contributes to efficient facility management and maintenance practices.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A method of conducting and reporting a survey regarding an assessment of a plurality of assets disposed at a survey site associated with a customer organization, the method comprising:
generating, by a computing system of a first business entity, a survey template comprising a plurality of asset assessment queries, each of the asset assessment queries corresponding to a request for data regarding an assessment of a status and/or condition of an associated one of the plurality of assets disposed at the survey site;
conducting the survey by a surveyor, the conducting of the survey including the surveyor accessing the survey template during execution of a software application managed by the computing system on a first user device of the surveyor, the conducting of the survey further including the surveyor submitting survey related data to the computing system regarding the status and/or condition of each of the associated assets as an entry to each of the corresponding asset assessment queries during execution of the software application on the first user device of the surveyor;
digitally reporting results of the survey to the customer organization following completion of the conducting of the survey.

2. The method of claim 1, wherein the survey related data corresponds to a text-based description of the status and/or condition of one of the assets.

3. The method of claim 1, wherein the survey related data corresponds to a numerical rating of the status and/or condition of one of the assets.

4. The method of claim 1, wherein the survey related data corresponds to an image showing the status and/or condition of one of the assets.

5. The method of claim 4, wherein the image is generated by the first user device of the surveyor.

6. The method of claim 5, wherein the image is a photographic image taken via utilization of a camera feature of the first user device.

7. The method of claim 6, wherein the software application is configured to redirect the first user device of the surveyor to the camera feature thereof when the surveyor is taking the photographic image.

8. The method of claim 6, wherein the software application is configured to retrieve a previously taken photographic image from a storage device of the first user device.

9. The method of claim 4, wherein the image includes an annotation generated thereover.

10. The method of claim 9, wherein the annotation includes text, an identifying marker, or a combination thereof.

11. The method of claim 9, wherein the annotation is generated during use of an editing feature of the software application.

12. The method of claim 1, wherein the survey related data corresponds to a geographic location of one of the assets.

13. The method of claim 12, wherein the survey related data corresponds coordinates of the one of the assets according to the geographic coordinate system (CGS).

14. The method of claim 13, wherein the survey related data is submitted when a GPS tracking feature of the first user device is activated.

15. The method of claim 1, wherein the survey related data corresponds to an optical code identifying one of the assets.

16. The method of claim 1, wherein digitally reporting the results of the survey to the customer organization following completion of the conducting of the survey includes generating a survey reporting website.

17. The method of claim 1, further comprising a step of assigning a surveyor to complete the survey.

18. The method of claim 1, wherein the conducting of the survey further includes the surveyor adding new asset assessment queries to the survey template via use of the software application.

19. The method of claim 1, wherein the customer organization is associated with a plurality of survey sites, and wherein the digitally reporting the results of the survey to the customer organization following completion of the conducting of the survey includes reporting the results of a plurality of the surveys conducted with respect to the plurality of the survey sites.

20. The method of claim 19, wherein the reporting of the results of a plurality of the surveys conducted with respect to the plurality of the survey sites includes grouping the results of a subset of the surveys for display together.
